(19) United States
(12) Patent Application Publication
(10) Pub. No.: US 2013/0185813 A1
(43) Pub. Date: Jul. 18, 2013

(54) ACTIVATION OF DEVICE HAVING LIMITED USER INTERFACE

(71) Applicants: Jonghoon Shim, Changwon-Si (KR); Hyoungjun Park, Changwon-Si (KR); Seungkyu Park, Changwon-Si (KR)

(72) Inventors: Jonghoon Shim, Changwon-Si (KR); Hyoungjun Park, Changwon-Si (KR); Seungkyu Park, Changwon-Si (KR)

(21) Appl. No.: 13/723,306

(22) Filed: Dec. 21, 2012

(30) Foreign Application Priority Data
Dec. 23, 2011 (KR) 10-2011-0141451

(51) Int. Cl. H04W 12/06

(52) U.S. Cl. CPC H04W 12/06
USPC 726/29

(57) ABSTRACT

An electronic device performing device activation includes: a wireless communication module operated in an access point (AP) mode to perform communication with a mobile terminal or operated in a client mode to perform communication with a server; an input unit configured to receive a signal requesting conversion of a mode of the wireless communication module; and a controller configured to convert a mode of the wireless communication module and generate device identification information, wherein when a mode conversion request signal is received by the input unit, the controller converts the wireless communication module to the AP mode, and when user authentication information is received from the mobile terminal, the controller converts the wireless communication module into the client mode and transmits an activation request for requesting performing a registration to a device management server based on the user authentication information and the device identification information.

The present disclosure relates to subject matter contained in priority Korean Application No. 10-2011-0141451, filed on Dec. 23, 2011, which is herein expressly incorporated by reference in its entirety.

### FIELD OF THE INVENTION

The present invention relates to an activation of a device and, more particularly, to an activation of a device having a limited user interface.

### DESCRIPTION OF THE RELATED ART

A device management refers to a technique of providing functions such as a customized setting, a remote management, updating, and the like. A device management technique may be used for the purpose of a manufacturing processing of a product, an initial setting after a purchase of a product, collective updating of errors and corrections, a remote management of a product, or the like.

As standardization technologies with respect to application programs of a mobile communication sector and a service sector, technologies stipulated by the open mobile alliance (OMA) have been used. OMA deals with mobile Web, Web browsing, DRM solutions IP multimedia, device management, mobile broadcasting, mobile-related document standardization, and the like. In particular, a standardization of technologies for a device management in OMA allows processes such as updating of firmware, software downloading, a new service, error correction, or the like, to be wirelessly performed.

In case of a control message following the standard with respect to the OMA device management technology requires a device authentication between an electronic device and a device management server, and to this end, device identification information is required to be generated. Also, in case of an electronic device having a limited user interface, processes for performing a user authentication and generating identification information are required to be prescribed to be different.

### SUMMARY OF THE INVENTION

In the related art OMA device management technology, a device having a limited user interface is not sufficiently considered. A device management protocol defines user interaction commands allowing for an interaction with a user when a certain fact is required to be provided to a user or a user configuration is required while a terminal is being managed.

However, when a device management client fails to perform the user interaction command by using a user interface thereof, it is prescribed such that the device management client simply returns an error code and performs termination. When the device management client may have assistance from a device providing a user interface, the device management client may perform the command by utilizing it. In particular, it may be prescribed such that when a device is initially activated, the device management client should perform an activation process together with the terminal having a user interface.

Thus, the present disclosure proposes a method of allowing a home appliance having a limited user interface to perform initial activation. Also, the present disclosure proposes a method of allowing an electronic device having a limited user interface to perform an initial activation by using a terminal having a user interface.

In an embodiment, an electronic device performing device activation is disclosed. The electronic device may include: a wireless communication module operated in an access point (AP) mode to perform communication with a mobile terminal or operated in a client mode to perform communication with a server; an input unit configured to receive a signal requesting conversion of a mode of the wireless communication module; and a controller configured to convert a mode of the wireless communication module and generate device identification information. When a mode conversion request signal is received by the input unit, the controller may convert the wireless communication module to the AP mode, and when user authentication information is received from the mobile terminal, the controller may convert the wireless communication module into the client mode, and transmit an activation request for requesting performing a registration to a device management server based on the user authentication information and the device identification information.

The one embodiment and other embodiments may include any one of the following features. The controller transmits and receives a device management message to and from the device management server, and before the device management message is received, the controller may transmit authentication information based on the device identification information to the device management server. Also, the device management message may be a message according to a device management standard of an open mobile alliance (OMA). Also, the authentication information based on the device identification information may be included in an SyncML (Synchronization Markup Language) message and transmitted. Also, the authentication information based on the device identification information may be included in device information included in a package 1 and transmitted. Also, the user authentication information received from the mobile terminal may be input by a user interface included in the mobile terminal. Also, the controller transmits the activation request including an alias to the server, and the alias may be registered to the device management server such that it corresponds to the device identification information. Also, the device identification information may be UUID (universally unique identifier).

Meanwhile, a product activation method is disclosed as another embodiment. The product activation method may include: receiving a mode conversion request signal; when the mode conversion request signal is received, changing a wireless communication module to an AP mode; transmitting a configuration page to a terminal through the wireless communication module; receiving a product activation request including user authentication information from the terminal; generating a device identifier; changing the wireless communication module to a client mode; and transmitting the product activation request to a server based on device identifier, the user authentication information, and the device identifier.

According to embodiments disclosed in the present disclosure, even when a user interface of an electronic device is limited, an initial activation may be performed on a device. Thus, the electronic device may perform a process of registration to a device management server by using a device identifier generated during the initial activation process. Thereafter, the electronic device may perform a device management process together with a management server according to an OMA device management standard. Also, according to embodiments disclosed in the present disclosure, a role of a management portal receiving user information and that of a management server performing a device management may be discriminated in a device management system.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view illustrating a device management system to which the technique disclosed in the present disclosure is applicable.

FIG. 2 is a view illustrating an example of an electronic device to which the technique disclosed in the present disclosure is applicable.

FIG. 3 is a view illustrating processes of exchanging messages for a device management between an electronic device following an OMA device management standard and a management server.

FIG. 4 is a flow chart illustrating an example of a method of activating the electronic device.

FIG. 5 is a view illustrating a process of performing a device management command through an OMA DM message between the electronic device and the management server.

### DETAILED DESCRIPTION OF THE INVENTION

The present invention may be embodied in many different forms and may have various embodiments, of which particular ones will be illustrated in drawings and will be described in detail. However, it should be understood that the following exemplifying description of the invention is not meant to restrict the invention to specific forms of the present invention but rather the present invention is meant to cover all modifications, similarities and alternatives which are included in the spirit and scope of the present invention. The terminology used herein is for the purpose of describing particular embodiments only and is not intended to be limiting of the invention. Unless otherwise defined, all terms used herein have the same meaning as commonly understood by one of ordinary skill in the art to which this invention pertains, and should not be interpreted as having an excessively comprehensive meaning nor as having an excessively contracted meaning. If technical terms used herein is erroneous that fails to accurately express the technical idea of the present invention, it should be replaced with technical terms that allow the person in the art to properly understand. The general terms used herein should be interpreted according to the definitions in the dictionary or in the context and should not be interpreted as an excessively contracted meaning.

As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, steps, operations, elements, components, and/or groups thereof.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

It will be understood that when an element is referred to as being “connected with” another element, it can be directly connected with the other element or intervening elements may also be present. In contrast, when an element is referred to as being “directly connected with” another element, there are no intervening elements present.

The exemplary embodiments of the present invention will now be described with reference to the accompanying drawings, in which like numbers refer to like elements throughout. In describing the present invention, if a detailed explanation for a related known function or construction is considered to unnecessarily divert the gist of the present invention, such explanation has been omitted but would be understood by those skilled in the art. The accompanying drawings of the present invention aim to facilitate understanding of the present invention and should not be construed as limited to the accompanying drawings. The technical idea of the present invention should be interpreted to embrace all such alterations, modifications, and variations in addition to the accompanying drawings.

Hereinafter, a term of a terminal is used, and the terminal may be called by other names such as UE (User Equipment), ME (Mobile Equipment), MS (Mobile Station), UT (User Terminal), SS (Subscriber Station), MSS (Mobile Subscriber Station), wireless device, handheld device, or AT (Access Terminal).

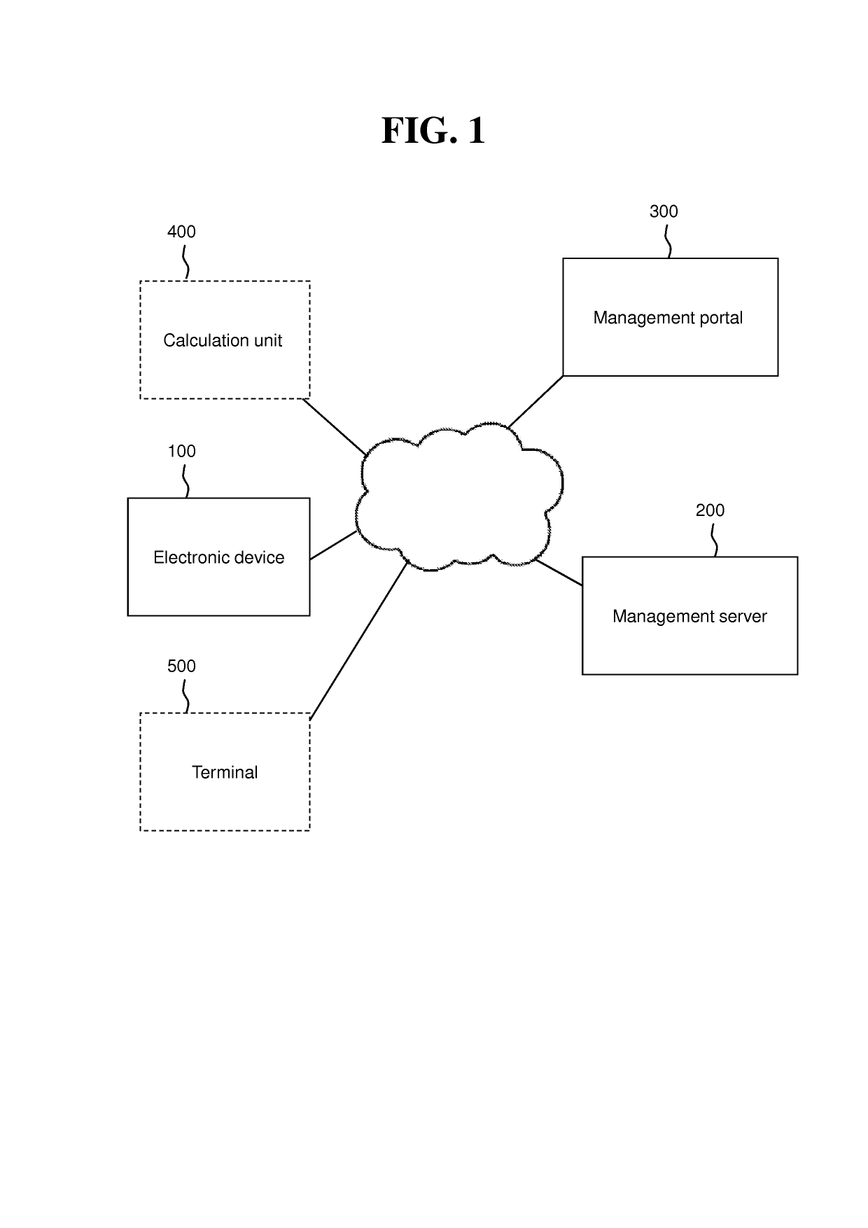

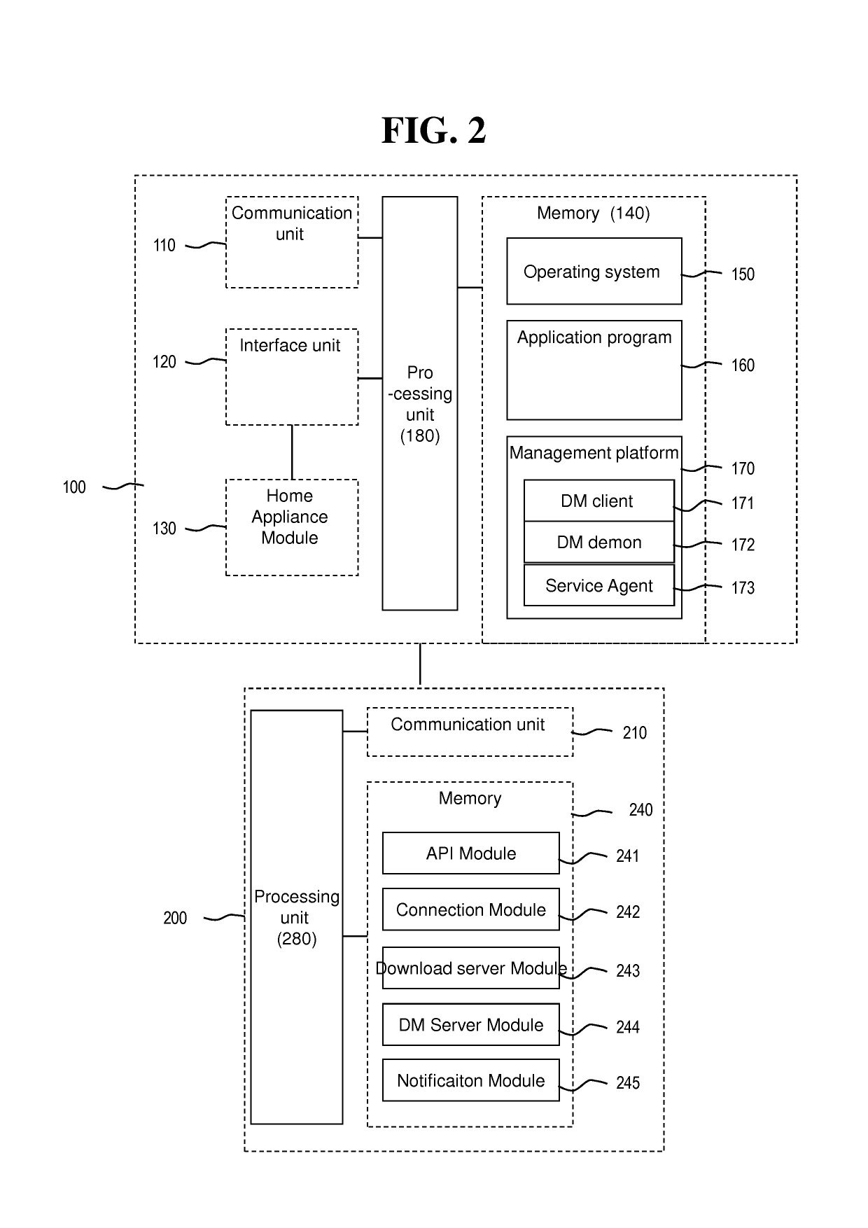

Entities in a device management system following the embodiments disclosed in the present disclosure will be described with reference to FIGS. 1 and 2. FIG. 1 is a view illustrating a device management system to which the technique disclosed in the present disclosure is applicable. FIG. 2 is a view illustrating an example of an electronic device to which the technique disclosed in the present disclosure is applicable.

With reference to FIG. 1, the device management system may be configured to include an electronic device 100 and a management server 200.

The electronic device 100 may be a target of a device management and correspond to various home appliances, communication devices, or the like. The electronic device 100 may perform a management command requested by the management server 200. The electronic device 100 may be a home appliance. The electronic device 100 may include a home appliance module 130 corresponding to hardware having a home appliance function, and may be an intelligent home appliance having application programs for utilizing the home appliance module 130 in various manners.

The management server 200 is a device executing a management service with respect to the electronic device 100. In particular, the management server 200 may include modules for requesting the electronic device 100 to perform a management command, receiving management command performing results from the electronic device 100, and providing the same to a user. Specific configurations of the electronic device 100 and the management server 200 will be described later with reference to FIG. 2.

The device management system may be configured to further include a management portal 300. The management portal 300 is a server providing a subscription and support service of a user of the electronic device 100. The management portal 300 may be configured to perform a function of managing the user of the electronic device 100 and a function of authenticating the product of the electronic device 100. The management portal 300 may be a device or a service system operated by a manufacturer of the electronic device 100 or a seller of the electronic device 100.

Meanwhile, the device management system may be configured to further include a computation device 400. The computation device 400 is a device used to access a service provided by the management portal 300. The computation device 400 may be a device including a network function such as, for example, a personal computer, or the like, or a user interface. The computation device 400 may be used to manage information regarding the electronic device 100 or the user.

Meanwhile, the device management system may be configured to further include a terminal 500. The terminal 500 is a device used to access a management service with respect to the electronic device 100 provided by the management server 200. The terminal 500 may use the management service through an API (Application Programming Interface) module provided from the management server 200. The terminal described in the present disclosure may be a certain electronic device which accesses the management server to use a management service with respect to the electronic device including a DM client. For example, the terminal may be interpreted to have a meaning of comprehensively including a mobile phone, a cellular phone, a smart phone, a PDA (Personal Digital Assistants), a PMP (Portable Multimedia Player), a tablet device, a computer, a multimedia device, or the like.

With reference to FIG. 2, the electronic device 100 may be configured to include a communication unit 110, an interface unit 120, a memory 140, and a processing unit 180.

The communication unit 110 is a communication module for transmitting and receiving a control message for performing a management command with the management server 200, data required for performing the management command, results of performing the management command, and the like. The communication unit 110 may be configured to include a wireless communication module 111 or a wired communication module 112 for performing communication with the management server 200. In particular, the wireless communication module is a module for performing communication with a device within a short range and may be a module supporting a short-range communication technology such as Bluetooth™, RFID (Radio Frequency Identification), infrared communication (IrDA (infrared Data Association)), UWB (Ultra Wideband), ZigBee™, Wireless LAN (Bluetooth, 802.11n, etc. protocol)

The wireless communication module 111 may be set to operate in an AP (Access Point) mode to perform communication with a mobile terminal or operate in a client mode to perform communication with a server. The electronic device 100 may be configured to include an input unit for receiving a signal for converting a mode of the wireless communication module 111. The input unit may be implemented in the form of a button. It may be difficult for the button type input unit to receive complicated inputs such as user information, or the like. However, for example, the button type input unit may receive an input signal for converting a mode of the wireless communication module 111 by using a time duration in which the button type input unit is being pressed, the number of times of pressing the button type input unit, and the like.

When the wireless communication module 111 operates in the AP mode, the wireless communication module 111 may perform communication with the terminal 500. To this end, the terminal 500 may perform a process of discovering the wireless communication module 111 and authenticating the wireless communication module 111 to establish a connection with the electronic device 100.

When the wireless communication module 111 operates in the client mode, the electronic device 100 may be connected to the management portal 300 or the management server through a network. To this end, the wireless communication module 111 operating in the client mode may be set to transmit and receive data through an AP therearound.

The interface unit 120 serves as a passage connected to the home appliance module 130 of the electronic device 100. The interface unit 120 may operate to allow state information and a control signal according to a management command to be transmitted and received for the home appliance module 130. The interface unit 120 may be implemented in the form of a library required for performing a management command between the home appliance module 13 and a DM client 171 or a DM demon 172.

The home appliance module 130 connected through the interface unit 120 may be hardware performing, for example, a washing function, a cooking function, a cleaning function, or a storage function. In detail, the processing unit 180 may control the home appliance module 130 connected through the interface unit 120 according to a control method included the application program 160 stored in the memory 140.

The memory 140 may store the program for operating the processing unit 180 or may temporarily store input or output data.

Also, the memory 140 may store various software components. In detail, the memory 140 may store an operating system (OS) 150, an application program 160, and a management platform 170. Also, the memory 140 may store software components including a module operated together with the communication unit 110 and a module operated together with the interface unit 120.

The operating system 150 (e.g., LINUX, UNIX, OS X, WINDOWS, Chrome, Symbian, WinCE, Windows Mobile, iOS, Android, Bada, VxWorks, pSOS, or any other embedded operating systems) may include various software components and/or drivers for controlling system tasks such as a memory management, a power management, and the like.

Meanwhile, the operating system 150 of the electronic device 100 may be configured such that a plurality of operating systems to operate in cooperation with each other. Namely, the electronic device 100 may be configured such that different operating systems are executed according to a type of an executed task, an amount of available resources in an executed environment, and the like. Also, the processing unit 180 may be implemented to include a plurality of controllers, and in this case, the plurality of operating systems may be operated as operating systems for operations of the respective controllers.

When it is assumed that the operating system 150 is divided into a first OS and a second OS, the first OS may be, for example, an operating system providing an operation environment of hardware performing a home appliance function of the electronic product 100, and the second OS may be, for example, a general-purpose operating system providing an environment for executing a general application program such as performing a function supporting a user interface of the electronic product 100 or an operation of the communication unit 110, or the like. For example, the first OS may be an operating system providing an environment having a small amount of resource such as a real-time operating system executed in a micro-controller unit (MCU), and the second OS may be a general-purpose operating system for executing various programs among embedded operating systems.

Meanwhile, the operating system 150 may be changed through a firmware updating process. The firmware updating process may be performed according to a management command transmitted to the DM client 171 through the DM server from the terminal 500. The management command for updating firmware may be a command for requesting performing of an upgrade function.

The application program 160 refers to a program executed in the operating system 150.

The application program 160 may be configured to include a program with respect to an intrinsic function of the home appliance module 130 mounted in the electronic device 100. In detail, the processing unit 180 may control the home appliance module 130 connected to the interface unit 120 according to the application program 160.

For example, when the electronic device 100 is implemented to include hardware having a washing function, state collecting signals and control signals for managing washing modules such as a washing drum control unit, a washing water supply unit, a sensor unit, a detergent adjustment unit, a vibration adjustment unit, or a level adjustment unit through the interface unit 120 are transmitted and received. In this case, the control signals, or the like, for managing the washing modules may be operated according to the application program 160 indicating a washing method, or the like, according to a washing course for designating washing, rinsing, a spin-dry method, order, time, a number of times, and the like, according to information of washing target such as a material of clothes, fabric, or the like.

In another example, when the electronic device 100 is implemented to include hardware having a cooking function, state collecting signals and control signals for managing cooking modules such as a cooking unit, a power/fuel control unit, an illumination unit, an air-conditioning unit, a sensor unit, and the like, through the interface unit 120 are transmitted and received. In this case, the control signals for managing the cooking modules may be operated according to the application program 160 indicating an operation mode, a cooking course, a cooking method according to a recipe, and the like.

In another example, when the electronic device 100 is implemented to include hardware having a cleaning function, state collecting signals and control signals for managing cleaning modules such as a driving unit, a cleaning unit, an obstacle detection unit, a position recognizing unit, or a sensor unit are transmitted and received through the interface unit 120. In this case, the control signals, or the like, for managing the cleaning modules may operate according to the application program 160 indicating a cleaning method.

In another example, when the electronic device 100 is implemented to include hardware having a storage function, control signals and state collecting signals for managing the storage module such as a cooling unit, a temperature control unit, a sensor unit, or the power controller, or the like, are transmitted and received via the interface 120. In this case, the control signals, or the like, for managing the storage module may be operated according to the application program 160 indicating a storage method, or the like, according to a storage mode, a ripening mode, or a storage mode.

Meanwhile, the application program 160 may be changed through a software updating process. The software updating process may be performed according to a management command transmitted to the DM client 171 through the DM server, and the management command for the software updating may be a command for requesting performing of an upgrade function.

The management platform 170 is a management program executed in the operating system 150.

The management platform 170 may be configured to include the DM client 171. The DM client 171 may transmit and receive a management message for managing the electronic device 100 with a device management (DM) server.

Management functions executed by the DM client 171 are management functions with respect to the home appliance module 130 installed in the electronic device 100 and include, for example, monitoring, diagnosing, upgrading, remote controlling, and the like.

The monitoring function is a function for monitoring a state of the home appliance module 130. The DM client 171 may be configured to collect log data or an event generated in the home appliance module 130. For example, when hardware having a washing function is installed in the electronic device 100, the DM client 171 may collect an event or log data with respect to items including an operational state, a remaining time duration, an initial set time, a washing course number, a rinsing level, a spin-drying RPM, a temperature, or a reserved washing time with respect to the hardware having the washing function.

Also, the diagnosing function is a function of diagnosing a state of the home appliance module 130. The DM client 171 may obtain results of detecting or diagnosing an error generated in the home appliance module 130 through the diagnosing function, through an agent.

The upgrading function may be a function of updating firmware, a service, or an application program of the electronic device 100. The DM client 171 may update the operating system 150, the application program 160, or the management platform 170 stored in the memory 140 through the upgrading function. Besides, the DM client 171 may update software components including a module operated together with the communication unit 110 and a module operated together with the interface unit 120 through the upgrading function.

The remote controlling function is a function of controlling the electronic device 100 from a remote area. The DM client 171 may control the operation of the home appliance module 130 through the remote controlling function. For example, when hardware having a storage function is mounted in the electronic device 100, the DM client 171 may instruct the hardware having the storage function to control a temperature of a refrigerating chamber, a freezing chamber, or the like, or perform a function such as quick freezing, or the like.

Also, the management platform 170 is configured to include a device management deamon (DM deamon) 172. The DM deamon 172 may receive a notification message transmitted from a notification module 245 of the management server 200, for the sake of the DM client 171. Also, the DM deamon 172 may perform a function of processing an exception of the DM client 171.

Also, the management platform 170 may be configured to include a service agent 173. The service agent 173 is used for the DM client 171 to control hardware in the electronic device 100 according to a management command or for the processing unit 180 to control the hardware by executing the application program.

Meanwhile, the memory 140 may include a RAM (Random Access Memory), an SRAM (Static Random Access Memory), a ROM (Read-Only Memory, an EEPROM (Electrically Erasable Programmable Read-Only Memory), a PROM (Programmable Read-Only Memory), a magnetic memory, a magnetic disk, a magnetic disk, an optical disk, a flash memory type, a hard disk type, a multimedia card micro-type, and a card type memory (e.g. SD or xD memory, etc.) Also, the memory 140 may have a form of a network storage connected through the communication unit 110 or a storage region form according to a storage function provided by a cloud service, or the like.

The processing unit 180 controls the elements of the electronic device 100 to perform the methods disclosed as embodiments of the present invention. Namely, the processing unit 180 controls the communication unit 110, the interface unit 120, and the memory 140.

The processing unit 180 may be configured to execute the software components stored in the memory 140. The processing unit 180 may control the home appliance module 130 connected to the interface unit 120 according to the application program 160.

Meanwhile, when the processing unit 180 is implemented to be divided into a plurality of controllers, unlike an MCU implemented in a separate board, the controllers executing a general-purpose operating system may be implemented to be connected to a display module, or the like, of the electronic device 100.

In order to perform a management command received from the management server 200 according to embodiments disclosed in the present disclosure, the controller 180 may execute or update the application program 160.

With reference to FIG. 2, the management server 200 may be configured to include a communication unit 210, a memory 240, and a processing unit 280.

The communication unit 210 may perform communication with the electronic device 100 and the terminal 500.

The memory 240 may store a program for operating the processing unit 280 and temporarily store input/output data. In particular, the memory 240 may store modules for transferring a request for performing a management command received from the terminal 500 to the electronic device 100 and receiving performing results of the management command from the electronic device 100. In detail, the memory 240 may be configured to include one or more of an API (Application Programming Interface) module 241, a connection module 242, a download server module 243, a device management server (DM) server module 244, and a notification module 245.

First, the API module 241 is an interface module providing a DM service to a terminal or an application program outside the management server 200. In detail, the API module 241 may be configured to include at least one of an interface function for authentication to check whether or not a terminal or an application program accessing the DM service is a permitted one, an interface function for remotely diagnosing the electronic device 100, an interface function for monitoring the electronic device 100, an interface function for controlling an application program of the electronic device 100, and an interface function for controlling the home appliance module 130 of the electronic device 100. Meanwhile, the function of providing the interface may be implemented to be provided by an independent device such as the API server.

Next, the connection module 242 may deliver a management command request message transmitted from a terminal outside the management server 200 to the electronic device 100 and perform a message delivery function for delivering results obtained by performing the management command according to the management command request message from the electronic device 100 to the management server 200. Meanwhile, the message delivery function may be implemented to be performed by an independent device such as the connection server.

Next, the download server module 243 may perform a function of transmitting download data to the electronic device 100. The download server module 243 may be a module for transmitting download data according to an OMA download standard. Meanwhile, the function of transmitting download data may be implemented to be performed by an independent device such as the download server.

Next, the DM server module 244 may perform a function of requesting performing of a management command through transmission and reception of a control message to and from a device management client (DM client) performing a function of management a device within the electronic device 100 and receiving performing results of the management command. The DM server module 244 may transmit and receive messages for the management command according to the OMA DM standard. Meanwhile, a function of transmitting and receiving a control message for the device management may be implemented to be performed by an independent device such as the DM server.

Next, the notification module 245 may perform a notification function of transmitting and receiving notification messages for a device management to and from the electronic device 100. The notification module 245 may exchange messages with the electronic device 100 and the DM server module in a push manner. Also, the notification function may be implemented to be performed by an independent device such as the notification server.

Meanwhile, in FIGS. 1 and 2, the management server 200 is illustrated as a single device, but the management server 200 may be implemented to be divided into a plurality of servers each performing a different role according to an embodiment. For example, the management server 200 may be divided into an API server, a connection server, a download server, a device management server, a notification server, and the like, so as to be implemented. Here, the dividing of the management server 200 into a plurality of servers is merely an example of an implementation method, and the configuration and method of the management server 200 disclosed in the present disclosure is not limited to be interpreted to an embodiment in the form of each independent server.

The processing unit 280 controls the components of the management server 200 to perform the methods disclosed in an embodiment of the present invention. Namely, the processing unit 280 controls the communication unit 210 and the memory 240. The processing unit 280 may be configured to execute the modules stored in the memory 240.

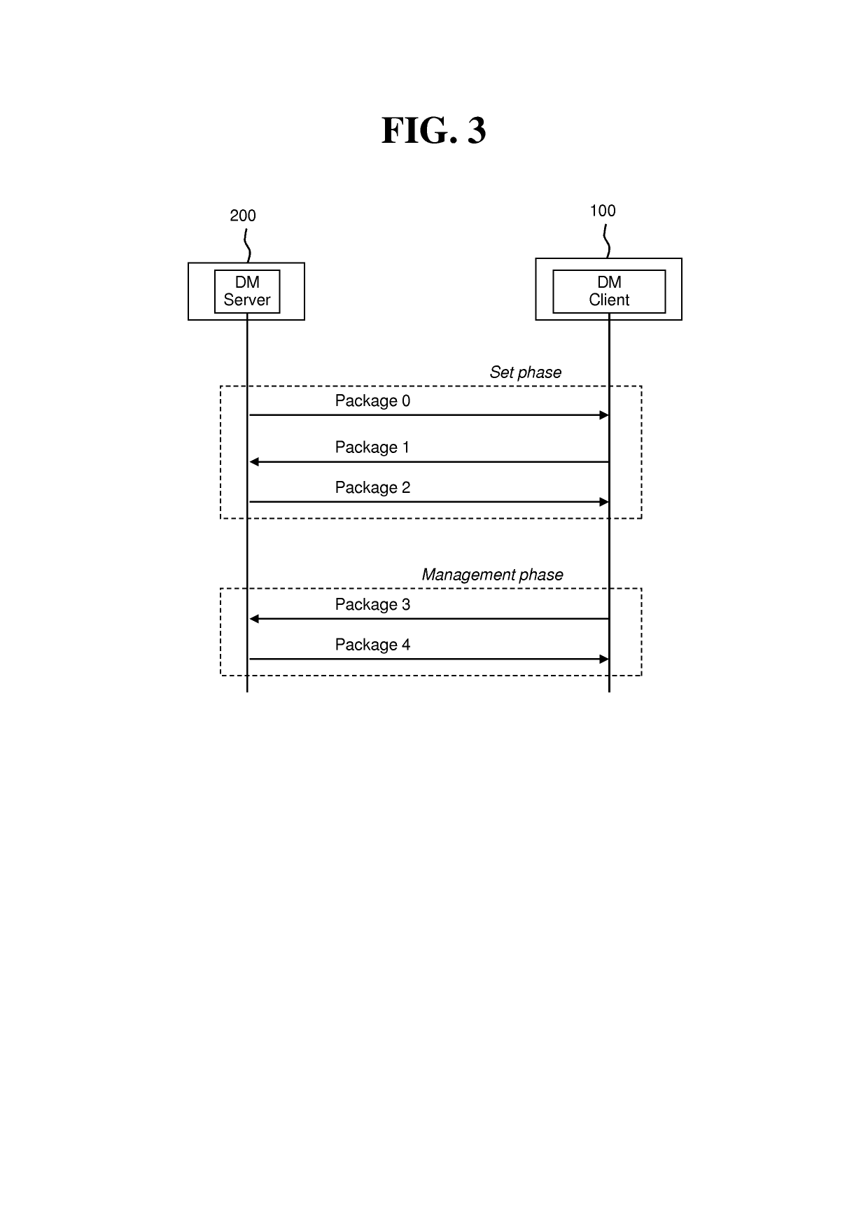

FIG. 3 is a view illustrating processes of exchanging messages for a device management between the electronic device following an OMA device management standard and the management server.

With reference to FIG. 3, the DM server of the management server 200 performs management on the electronic device 100 by exchanging control messages following a device management (DM) standard of an open mobile alliance (OMA) with the DM client 171 included in the electronic device 100.

First, the management server 200 and the electronic device 100 may perform an operation of a setup phase by transmitting and receiving a package 0 (Package #0), a package 1 (Package #1), and a package 2 (Package #2). The setup phase is a phase for exchanging authentication and device information.

In detail, the management server 200 transmits the package 0 corresponding to a trigger message for starting a management session to the electronic device 100. Upon receiving the package 0, the electronic device 100 transmits the package 1 including authentication information (credentials) of the DM client 171 and device information to the management server 200. The authentication information of the DM client 171 included in the package 1 may be a device identifier as described hereinafter. Next, upon receiving the package 1, the management server 200 checks the authentication information of the DM client 171, and when the results of the checking is valid, the management server 200 transmits the package 2 including the authentication information (credentials) of the DM server and the management command to the electronic device 100.

Next, the management server 200 and the electronic device 100 performs an operation of a management phase by transmitting and receiving the package 3 (Package #3) and the package 4 (Package #4). The management phase is a phase of transmitting performing results with respect to the management command transmitted in the setup phase to the management server 200. The packages of the management phase may be continuously transmitted and received until when the transmission of the performing results with respect to the management command is completed.

In detail, the electronic device 100 transmits the package 3 including a response to the management command to the management server 200. After the management server 200 receives the package 3, when an additional process is required for the management command, the management server 200 transmits the package 4 indicating the necessity of an additional process to the electronic device 100.

In exchanging the control messages following the OMA device management standard as described above, the packages are data configured by a markup language such as a SyncML (Synchronization Markup Language) message, or the like, and the packages are included in a body of a request/response according to HTTP (Hypertext Transfer Protocol) and transmitted and received. Also, in order to exchange the packages, transmission units of the electronic device 100 and the management server 200 may use various transmission protocols. When the electronic device 100 has a wireless communication function, an SMS (short message service), a WAP (wireless application protocol) Push, or the like, may be used to transmit the packages, and when the electronic device 100 has an IP (Internet Protocol)-based network communication function, a connection through a general TCP (Transport Control Protocol) socket, a connection through an SSL (Secure Socket Layer), or the like, may be used.

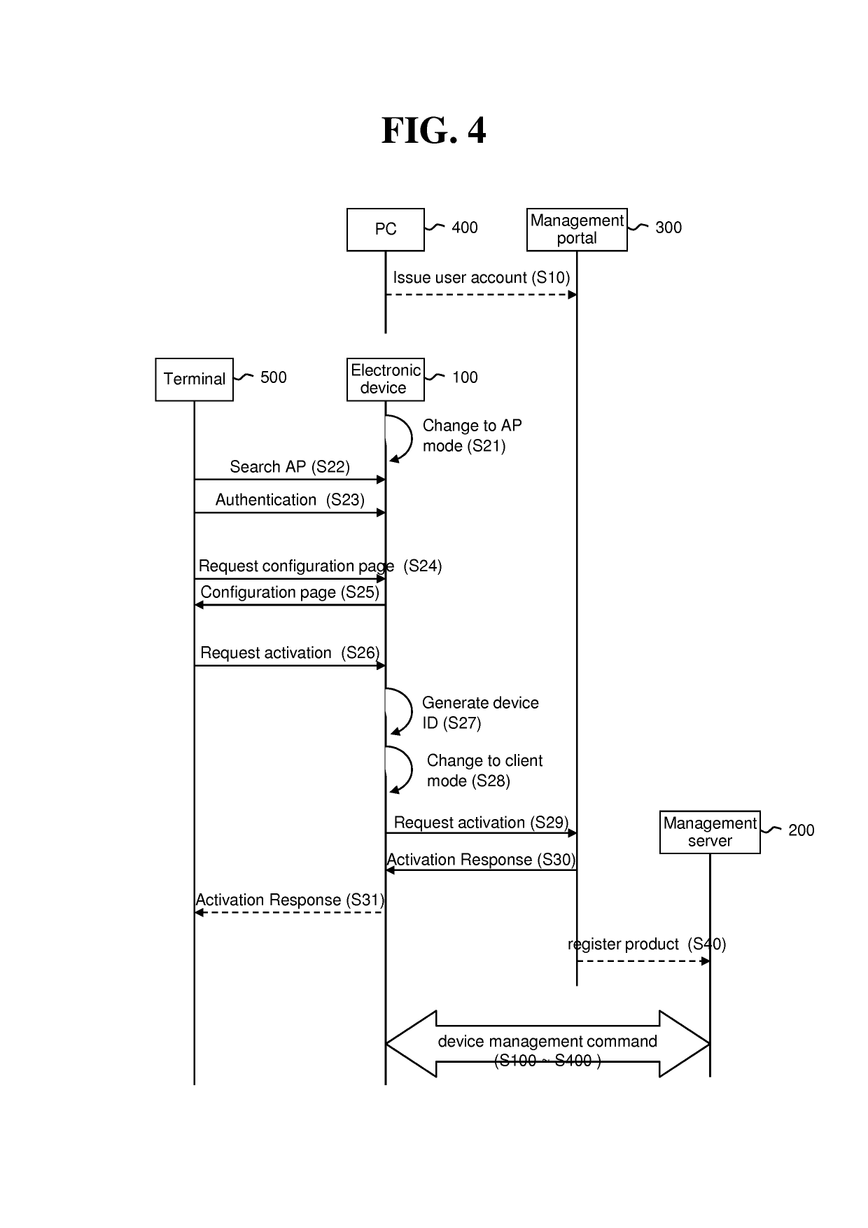

Hereinafter, a method of activating an electronic device applicable to embodiments disclosed in the present disclosure will be described. FIG. 4 is a flow chart illustrating an example of a method of activating the electronic device.

First, the user may access the management portal 300 by using the computation device 400 or a PC to receive an issued user account (S10). For example, the issuance of the user account refers to generating a user ID and determining a password. User information such as the user ID and password may be managed by the management portal 300.

Next, when the electronic device 100 receives an input signal for requesting a conversion into an AP mode, an operation mode of the wireless communication module 111 is changed to an AP mode (S21).

The input signal for requesting the AP mode conversion may be input by an input unit formed in the electronic device 100. The input unit may be a particular button formed on the outside of the main body of the electronic device 100.

The mode of the wireless communication module 111 is converted into an AP mode in which the terminal 500 is set to form a local network or a connecting point to access the electronic device 100. When the wireless communication module 111 is a communication module performing Wi-Fi communication, the AP mode may establish a wireless local network environment in an infrastructure mode having a particular SSID (Service Set Identifier) allowing the terminal 500 to perform searching.

Thereafter, the terminal 500 searches a connecting point formed by the wireless communication module 111 which has been changed to the AP mode (S22). The searching may be a process of searching for an SSID in the case of Wi-Fi. Through the searching, the terminal 500 may receive access information required for performing communication with the electronic device 100.

Thereafter, the terminal 500 performs an authentication process to transmit and receive data through the wireless communication module 111 (S23). When there is an authentication process required for accessing a wireless network formed by the electronic device 100, the terminal 500 performs the authentication process and accesses the wireless network.

Thereafter, the terminal 500 requests a configuration environment required to perform an initial activation of the electronic device 100 (S24). The request for a configuration environment may be a request for an interface in the form of a Web page for activation. To this end, the terminal 500 may request the configuration environment by inputting a predetermined access address for the configuration environment. For example, the access address may be expressed in the form of a URL (Uniform Resource Locator).

Thereafter, the terminal 500 receives the configuration environment and displays the received configuration environment on a display of the terminal 500 (S25). When the configuration environment is provided in the form of a Web page, the terminal 500 displays the Web page on the display.

Thereafter, the terminal transmits an activation request including user information received from the user to the electronic device 100 (S26). The user information indicates user account information generated upon accessing the management portal 300. The terminal 500 may receive the user information through an input window of the Web page, include the input user information in information for the activation request, and transmit the same.

Thereafter, upon receiving the activation request, the electronic device 100 generates a device identifier (S27). The device identifier may be information in the form of a UUID. The device identifier may be generated in the form of a random number.

Thereafter, the electronic device 100 changes the wireless communication module 111 into a client mode (S28). The client mode refers to an operation state in which the electronic device 100 can perform communication with the management portal 300 or the management server 200 by using the wireless communication module 111.

Thereafter, the electronic device 100 transmits the activation request including the user information and the device identifier to the management portal 300 (S29). The user information serves as authentication information indicating that the user is a valid user to the management portal 300. The activation request may include other information regarding the electronic device 100 or the user. For example, the activation request may include an alias with respect to the electronic device 100 and the alias is a title designating the electronic device 100 for the convenience of the user instead of the device identifier of the electronic device 100. Besides, the activation request may include a manufactured product number for managing the electronic device 100.

Thereafter, the management portal 300 checks whether or not the user information included in the activation request is valid, and transmit an activation response including the results to the electronic device 100 (S30).

Thereafter, the electronic device 100 may transmit the activation response, which has been received from the management portal 300, as a response to the activation request in step S26 to the terminal 500 (S31). To this end, the electronic device 100 may change the mode of the wireless communication module 111 to the AP mode.

Thereafter, the management portal 300 transmits the device identifier to the management server 200 to thus perform a product registration request (S40). The product registration request may include the user information, and in this case, the management server 200 which has received the product registration request may perform a registration process by associating the user ID included in the user information and the device identifier of the electronic device 100. The product registration request may further include a device type, a device model name, a country code, a device serial number, whether or not the alias is used, or the alias, and the management server 200 may perform the registration process by associating these information to the device identifier.

Thereafter, when the product registration request is successfully performed, a device management command may be performed based on the device identifier, or the like, used for the product registration between the electronic device 100 and the management server 200 (S100 to S400).

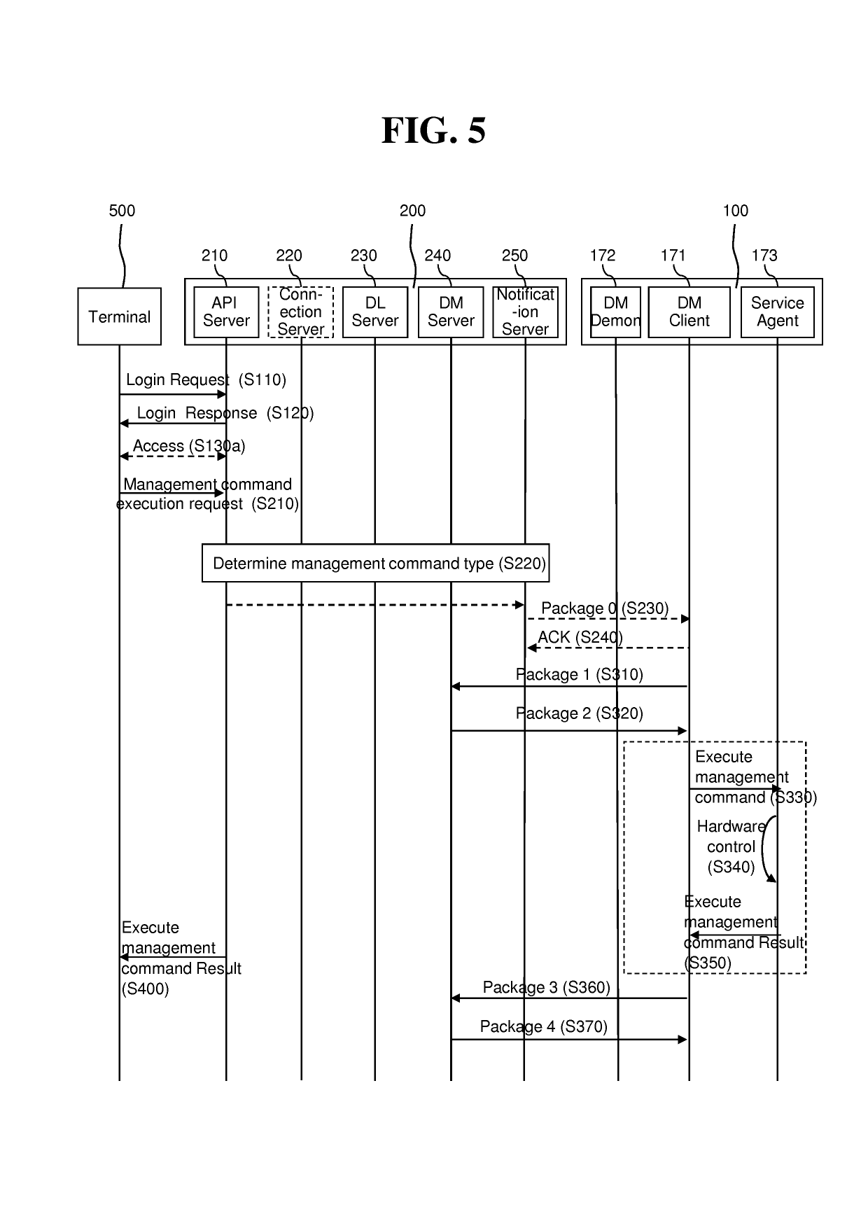

Hereinafter, a method for providing a device management service based on a device identifier used for registering a product after a device activation is disclosed. FIG. 5 is a view illustrating a process of performing a device management command through an OMA DM message between the electronic device and the management server.

First, the terminal 500 transmits a log-in request message including authentication information with respect to the management server 200 (S110), and the management server 200 determines whether or not the terminal 500 has authority to request performing of a management command based on the authentication information and transmits the determination results to the terminal 500 (S120).

Next, the terminal 500 establishes a connection with the management server 200 when necessary (S130). In case in which a connection between the terminal 500 and the management server 200 has been already established and maintained through the log-in request process (110) or for any other purpose, the connection establishing process (S130) may be omitted.

Thereafter, the terminal 500 transmits a message for requesting a management command to the management server 200 through the connection established between the terminal 500 and the management server 200 (S210). The message for requesting the management command may be transmitted through an API provided by the management server 200. Alternatively, the request for the management command may be included in the log-in request message in step S110 and transmitted.

Thereafter, the management server 200 determines a type of the message for requesting the management command transmitted from the terminal 500 (S220). Thereafter, the management server 200 transmits a message indicating that the electronic device 100 may receive the management command (S230). When a type of the message requesting the management command is determined to be a type of a non-real time message, the message indicating that the management command is received may be a trigger message indicating that the electronic device 100 may start a process of receiving the management command. In detail, the message indicating that the management command is received may be a package 0 generated according to the OMA DM standard. Thereafter, the management server 200 may transmit a reception response (ACK) message with respect to the indication message to the management server 200.

Thereafter, upon receiving the indication message, the electronic device 100 transmits the message including the authentication information of the DM client 171 to the management server 200 (S310). The message including the authentication information of the DM client 117 may be a package 1 generated according to the OMA DM standard. The authentication information of the DM client 171 may be a device identifier generated in the foregoing activation process and provided for a device registration to the management server 200.

Thereafter, upon receiving the authentication information of the DM client 171, the management server 200 verifies the authentication information of the DM client 171, and when the authentication information of the DM client 171 is valid, the management server 200 transmits the message including the management command and the authentication information of the DM server 240 to the electronic device 100 (S320). The message including the management command and the authentication information of the DM server 240 may be a package 2 generated according to the OMA DM standard.

Thereafter, upon receiving the authentication information of the DM server 240, the electronic device 100 verifies the authentication information of the DM server 240, and when the authentication information of the DM server 240 is valid, the electronic device 100 performs the management command. The process of performing the management command by the electronic device 100 may include, for example, transmitting, by the DM client 171, a control signal according to the management command to the service agent 173 that controls hardware of the electronic device 100 (S330), and controlling, by the service agent 173, the home appliance module 130 in the electronic device 100 according to the control signal (S340) and transmitting the control results to the DM client 171 (S350).

Thereafter, the electronic device 100 transmits performing results of the management command to the management server 200 (S360). The performing results of the management command may be a package 3 generated according to the OMA DM standard.

Thereafter, when an additional process with respect to the management command is required, the management server 200 may transmit a message indicating performing of the additional process to the electronic device 100 (S370). The message indicating performing of an additional process may be a package 4 generated according to the OMA DM standard.

Thereafter, when there is a need to send the performing results of the management command to the terminal 500 according to a type of the management command, the management server 200 may perform a process of transmitting the management command to the terminal 500 (S400).

In the embodiments as described above, the components and features of the present invention are combined in a certain form. Respective elements or features should be considered to be selective unless otherwise mentioned. The respective components or features may be implemented such that they are not combined with other components or features. Also, some of the components and/or features may be combined to configure an embodiment of the present invention. The order of operations described in the embodiments of the present invention may be changed. Some components or features of one embodiment may be included in another embodiment or may be replaced with components or features corresponding to another embodiment. It is obvious that claims not in an explicit cited relationship in the claim coverage may be combined to configure an embodiment or may be included in a new claim by amendment after filing.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. An electronic device performing a device activation, the electronic device comprising:
a wireless communication module operated in an access point (AP) mode to perform communication with a mobile terminal or operated in a client mode to perform communication with a server;
an input unit configured to receive a signal requesting conversion of a mode of the wireless communication module; and
a controller configured to convert a mode of the wireless communication module and generate device identification information,
wherein when a mode conversion request signal is received by the input unit, the controller converts the wireless communication module into the AP mode, and when user authentication information is received from the mobile terminal, the controller converts the wireless communication module into the client mode and transmits an activation request for requesting performing a registration to a device management server based on the user authentication information and the device identification information.

2. The electronic device of claim 1, wherein the controller transmits and receives a device management message to and from the device management server, and before the device management message is received, the controller transmits authentication information based on the device identification information to the device management server.

3. The electronic device of claim 2, wherein the device management message is a message according to a device management standard of an open mobile alliance (OMA), and the authentication information based on the device identification information is included in an SyncML (Synchronization Markup Language) message and transmitted.

4. The electronic device of claim 3, wherein the authentication information based on the device identification information is included in device information included in a package 1 and transmitted.

5. The electronic device of claim 1, wherein the user authentication information received from the mobile terminal is input by a user interface included in the mobile terminal.

6. The electronic device of claim 1, wherein the controller transmits the activation request including an alias to the server, and the alias is registered to the device management server such that it corresponds to the device identification information.

7. The electronic device of claim 1, wherein the device identification information is a UUID (universally unique identifier).

8. A product activation method comprising:
receiving a mode conversion request signal;
when the mode conversion request signal is received, changing a wireless communication module too an AP mode;
transmitting a configuration page to a terminal through the wireless communication module;
receiving a product activation request including user authentication information from the terminal;
generating a device identifier;
changing the wireless communication module to a client mode; and
transmitting the product activation request to a server based on device identifier, the user authentication information, and the device identifier.
